(19) United States
(12) Patent Application Publication
(10) Pub. No.: US 2008/0278606 A9
(43) Pub. Date: Nov. 13, 2008

(54) Image compositing

(76) Inventors: Milivoje Aleksic, Richmond Hill (CA); Ivan Yang, Markham (CA); Wilson Yu, Markham (CA)

Correspondence Address: SMART AND BIGGAR, 438 UNIVERSITY AVENUE, SUITE 1500 BOX 111, TORONTO, ON, M5G2K8, CA

(21) Appl. No.: 11/215,932

(22) Filed: Sep. 1, 2005

(51) Int. Cl. H04N 5/262; H04N 1/46; G06K 9/54; G06K 9/60

(52) U.S. Cl. 348/239; 358/540; 382/302

(57) ABSTRACT

A method and apparatus for image compositing in an apparatus a device in which available memory is at a premium are disclosed. The apparatus includes a first memory that receives a video input signal, in multiple portions. The first memory has a storage capacity less than the entire video image. Data within the first memory is encoded to form encoded video image portions. The entire image is thus encoded, video image portion by video image portion. A second image is combined with image portions in the first memory prior encoding such video image portions. The apparatus may, for example, be an electronic component or components forming a video or image processing pipeline, used in a portable device.

### FIELD OF THE INVENTION

The present invention relates generally to video and image processing devices, and more particularly to components used to manipulate images. Such components are particularly useful within a device in which available memory is at a premium.

### BACKGROUND OF THE INVENTION

In today's computerized and networked world, there is an increased demand for portability and improved functionality in video and imaging components, typically embodied as video and image processing pipelines within integrated electronic components. Such components are particularly useful in devices in which available memory is at a premium, such as handheld devices. Example handheld devices include cellular phones, personal digital assistants (PDA), pagers, smart phones, music (e.g. mp3) players, or other suitable portable electronic device capable of providing graphical interactivity. Moreover, with the convergence of handheld devices and stand alone computing systems, such as desktop or laptop computers, there is a greater demand for improved functionality and quality of interactivity between multiple handheld devices and also between the handheld device and the stand alone computing system.

Recently, devices have begun to include components to acquire, render and transmit graphical and/or video images. One example of convergence of multiple technologies is the placement of cameras on the handheld devices. With these graphic intensive applications, there exist limitations imposed by conventional graphics architectures for generating the graphical output.

One common problem in such devices is the available memory resources. Current graphics techniques require extensive amounts of memory. This is particularly true when an image requires further modifications or manipulations (e.g. image composition, pixel corrections).

Although increasing available memory in such devices is appealing, the limited physical space for placing graphics placing memory is often a severe limitation. Moreover, the cost of adding more memory is typically too high to be practical. As devices become more compact, there exists less space for the insertion of additional memory needed for image rendering. Therefore, problems arise in attempting to utilize existing graphics processing components, and video and image processing pipelines in such devices.

As such, there exists a need for a method and apparatus that overcomes the memory resource requirements within devices and allows for quality image processing, and in particular video image compositing.

### SUMMARY OF THE INVENTION

Generally, the present invention provides a method and apparatus for image compositing in which available memory is at a premium. For example, large amounts of memory may simply not be available, or use of memory may consume too much power. The apparatus includes a first memory that receives a video input signal, in multiple portions. The first memory has a storage capacity less than the entire video image. Data within the first memory is encoded to form encoded video image portions. The entire image is thus encoded, video image portion by video image portion. A second image is stored within a second memory. The image is combined with image portions in the first memory prior encoding the video image portion. The apparatus may for example be an electronic component or components forming a video or image processing pipeline, used in a portable or other device. For example, the apparatus could be used in a camera, (such as a still or video camera), cell-phone, laptop computing devices, other computer or even in a printer.

In accordance with an aspect of the present invention, there is provided an apparatus for processing a video frame in a device. The video frame is divisible into a plurality of video image portions. The apparatus includes a first memory that receives the video image portions, the first memory having a storage capacity less than all of the plurality of video image portions of the video frame; a second memory storing image data to be combined with the video frame; a graphics processor coupled to the first memory and the second memory to selectively combine data within the first memory and image data within the second memory to produce at least one composite video image portion, and to encode at least some of the video image portions and the composite image portion video image portion to form an encoded video image; and a third memory receiving the encoded video image.

In accordance with another aspect of the present invention, there is provided a method of compositing a first image with a second image. The method includes, receiving the first image as a plurality of image portions of video data; writing each portion of video data to a first memory having a storage capacity insufficient to store all of the plurality of image portions of video data; storing data representing the second image; selectively combining at least one of the portions of video data in the first memory with data within the data representing the second image to form at least one composite video image portion; graphically processing portions of video data from the first memory, and the at least one composite video image portion to generate encoded video portions; and writing the encoded video portions to a storage memory.

In accordance with yet another aspect of the present invention, there is provided an apparatus for processing a video frame in a device. The video frame is divisible into a plurality of video image portions. The apparatus includes, a first memory for receiving and storing individual ones of the video image portions, without concurrently storing of all of the plurality of video image portions of the video frame; a second memory storing image data to be combined with the video frame; a graphics processor coupled to the first memory and the second memory to selectively combine data within the first memory and data within the second memory to produce at least one composite video image portion, and to encode at least some of the video image portions and the composite image portion video image portion to form an encoded video image; and a third memory receiving the encoded video image.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In figures which illustrate by way of example only, embodiments of the present invention,

FIG. 1 is a simplified schematic block diagram of an image processing pipeline in a handheld device;

FIG. 2 is a graphical representation of a handheld device, exemplary of an embodiment of the present invention;

FIG. 3 is a schematic block diagram of the image processing pipeline in the handheld device of FIG. 2;

FIG. 4 is a functional block diagram of aspects of the handheld device of FIG. 2;

FIG. 5 is a flow chart of an exemplary method performed in the device of FIG. 2; and

FIGS. 6-8 illustrate example images as combined in manners exemplary embodiments of the present invention.

### DETAILED DESCRIPTION

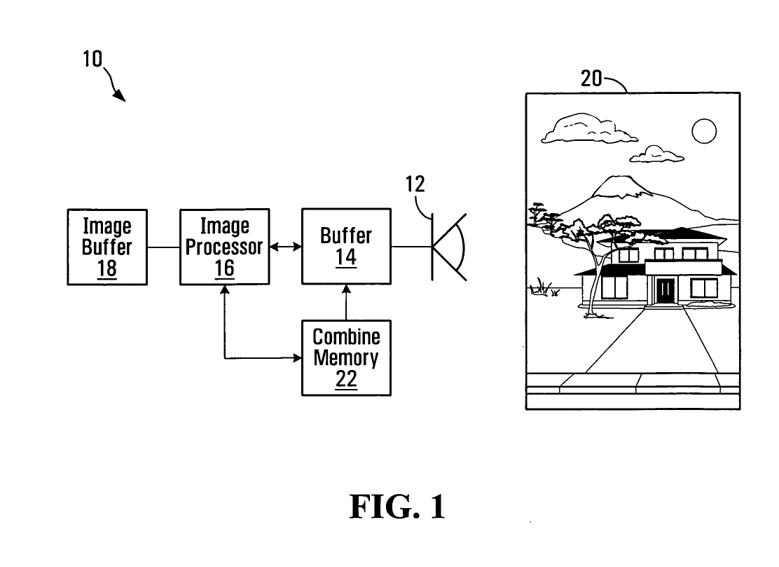

FIG. 1 illustrates a conventional image processing apparatus, often embodied as a video and image processing pipeline of a device 10. Device 10 includes camera 12, a fixed size buffer in memory 14, an image processor 16 and a maximum decode size buffer 18. Camera 12 is capable of capturing a video image 20. Video image 20 is provided to the fixed sized buffer in memory 14. In device 10, the buffer in memory 14 must be large enough to capture a single frame of image 20 and is dependent on the size of the image 20 acquired by camera 12. For example, if camera 12 acquires image 20 with a resolution of 64 lines of 16 bits, buffer in memory 14 would contain enough memory locations to store this single image 20. Although, larger memory 14 may be utilized to provide the ability of acquiring a streaming video or multiple images, as recognized by one having ordinary skill in the art.

Once image 20 is within buffer in memory 14, it may be modified. For example, a date and time stamp may be placed on the image. Further, some cameras allow the overlay of a border or frame around the image in memory 14. The overlay image may be stored in a further memory 22. Typically, memory 22 has the same size as the image buffer in memory 14. Contents of memory 22 may then be combined bit-for-bit with the captured image. For example, the image in buffer 14 may be masked by those areas within memory 22 that store the image to be overlaid. Suitable overlays may be stored in read only memory or may be generated as required. Combining of memory 22 and memory 14 may be performed by processor 16 or another processor (not shown) forming part of device 10.

Once an image is captured in the buffer in memory 14, and combined with another image, processor 16 generates an encoded image that is stored in memory 18. The encoded image may be compressed, using for example, known image compression techniques such as the JPEG compression, JPEG2000 compression, GIF compression, or any other suitable compression technique. The size of memory 18 is fixed by the size of the encoded image. Therefore, the image processing pipeline of device 10 has two buffers, in memories 14 and 18, and a further image memory 22. The sizes of the buffers and memories 14, 18 and 22 are dictated by camera 12 and the maximum size of the image 20. For high resolution images, without a compromise in quality, two large memories 14 and 18 are required.

In the conventional device 10, image 20 is then displayed to the user in a thumbnail fashion. In one embodiment, processor 16 retrieves a stored, encoded image from buffer 18 and again decodes it in accordance with known processing techniques to present it on an integrated display (not shown). For example, compressed encoded images may be retrieved and decompressed.

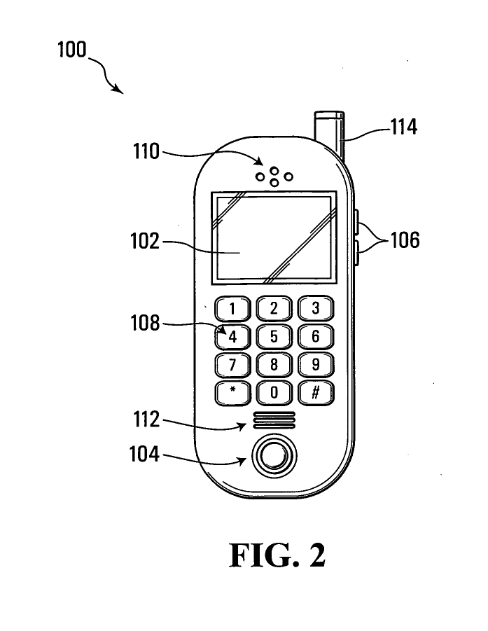

FIG. 2 illustrates a device 100, exemplary of an embodiment of the present invention. Depicted device 100 is a handheld cellular telephone. However, as will be appreciated, aspects of the invention may be incorporated in any suitable device, such as a personal digital assistant (PDA), camera, digital music player, other portable device or the like. In particularly, aspects of the invention are particularly useful in devices where memory and/or physical space are at a premium.

Example device 100 includes a display 102 and a camera 104, optional navigational buttons 106, keypad 108, speaker 110, and microphone 112, all within a case. Device 100 may further include an antenna 114 for communication with a wireless or cellular communications network.

Camera 104 provides for video acquisition and is positioned on the front of device 100. As recognized by one having ordinary skill in the art, camera 104 may be positioned at any other suitable location in or outside the case of device 100. Camera 104 includes a suitable lens and may include a charge-coupled device (CCD). Moreover, additional cameras (not illustrated) could be disposed on the device 100.

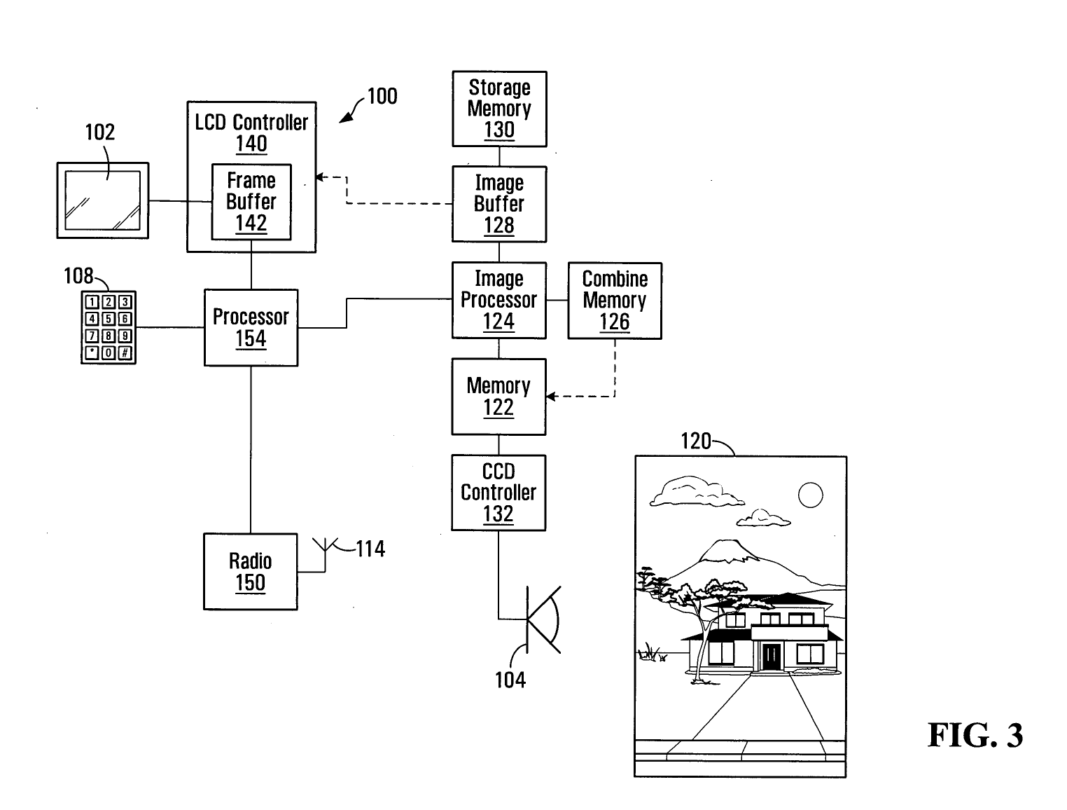

FIG. 3 is a simplified schematic diagram of portions of device 100 used for image processing. Again, camera 104, keypad 108 and display 102 are depicted. As illustrated, device 100 further includes a first memory 122, a graphics processor 124, a second memory 126 and a third memory 128.

As noted, device 100 may be a cellular telephone, and may thus optionally further include a baseband radio receiver 150 coupled to antenna 114 for wireless communication.

Receiver 150 and graphics processor 124 are operably coupled to a central processing unit (CPU) 154 that controls overall operation of device 100. As recognized by one having ordinary skill in the art, CPU 154 may be any suitable processor useable mobile device.

Device 100 also includes a storage memory 130. Storage memory 130 may be removable from device 100, and may be a secure digital (SD) memory card, compact flash memory, a micro-disk-drive, or the like. Memory 130 may further be accessible directly by processor 154.

Device 100 may also include a display controller 140 connected with display 102. Display controller 140 further includes a frame buffer 142. Display controller 140 provides a viewable output signal to display 102. Display 102 may take the form of LCD or any other suitable display device as recognized by those of ordinary skill.

Camera 104 is in communication with memory 122. In one embodiment, first memory 122 and third memory 128 are double buffer memories capable of storing portions of a digitally encoded frame of video data. Advantageously, double buffer memories allow graphic processor to quicky acquire and process images. Moreover, camera 104 is a CCD that generates a video signal that may be a rasterized depiction of an image 120. A suitable CCD controller 132 may provide samples of CCD to memory 122, one line at a time, thereby providing image 120 to memory 122, line by line.

First memory 122 has a storage capacity less than that required for the entire video frame data 120 for the encoded video frame. First memory 122 thus stores only a portion of the entire video image.

For example, the video frame may be divided vertically or otherwise into portions. The video input signal from camera 104 may be provided to memory 122 one portion of these portions at a time. Portions are transferred sequentially to memory 122. If dual buffer memory is used, one image portion may be processed as another is being encoded, thereby reducing any delays in image processing/acquisition. In one embodiment, each portion represents a defined number of horizontal scan lines of a digital representation of image 120. A counter may track which image portion of the image 120 is currently within memory 122. This might be effected by counting the starting line number within the video frame of the video portion currently within memory 122.

Second memory 126 stores image data that is to be combined with captured video image data, as detailed below. The image data in second memory 126 may, for example, be graphical components used to enhance the appearance of captured video image. For example, second memory 126 may store data used to define a border around a captured image. Second memory 126 may similarly store data representing an icon, a watermark, a date or timestamp, or the like. Second memory 126 may also store data representing a variety of image(s) or image portions.

First memory 122, second memory 126 and third memory 128 are processor readable computer memory and may for example be a single memory having a plurality of memory locations, multiple memory devices, shared memory, CD, DVD, ROM, RAM, EEPROM, optical storage, or any other non-volatile storage medium capable of storing digital data. In one embodiment first memory 122 and third memory 128 may both be formed in an embedded memory device. Memory 126 may be a separate memory storing pre-programmed compositing data or compositing data generated by CPU 154.

Graphics processor 124 may for example be a single processor, a plurality of processors, a digital signal processor (DSP), a microprocessor, ASIC, state machine, or any other electronic entity capable of processing and executing software or discrete logic or any suitable combination of hardware, software and/or firmware. The processor should not be construed to refer exclusively to hardware capable of executing software, and may implicitly include DSP hardware, ROM for storing software, RAM, and any other volatile or non-volatile storage medium. Software may be stored within graphics processor 124 or in external memory (not shown).

As will become apparent, an image 120 is captured by camera 104, provided in portions to memory 122, optionally combined with image data in memory 126, encoded into a suitable graphics format and stored in third memory 128.

Graphics processor 124 operates on captured video image portions, or composited video image portions and encodes these portions. Graphics processor 124 operates in accordance with known image processing techniques to generate an encoded image portion for each image portion in memory 122. For example, processor 124 may use a discrete cosine transform (DCT) and run length encoding, such as for example found in the JPEG-ISO_IEC_{—}10918-1_{—}1994 standard, to encode video image portions. Alternate graphics encoding/compression techniques such as image sharpening, progressive JPEG, JPEG 2000, H.263, MPEG4, H.264, or other techniques appreciated by those of ordinary skill could similarly be used by processor 124.

Encoded video portions are provided to third memory 128. Third memory 128 thereupon provides encoded video portions to a storage memory 130. Additionally, encoded images in third memory 128 may again be decoded by processor 124 and provided to frame buffer 142 for display on display 102.

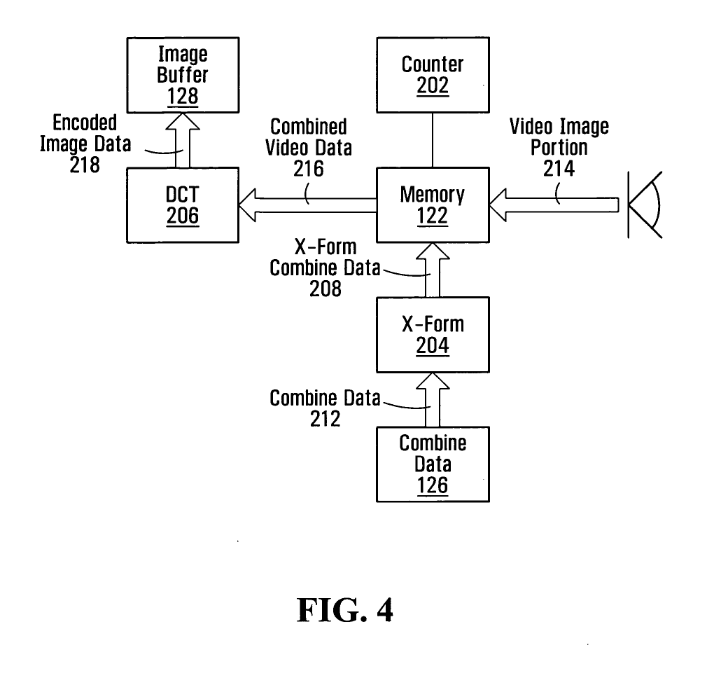

FIG. 4 is a functional block diagram of elements of device 100, illustrating data stored/transferred between blocks. As illustrated, camera 104 provides video image portions 214 to memory 122. Compositing image data 210 is stored within third memory 126. Portions 212 of the compositing image data 210 are provided to a transform block 204, which may be a filter, decompressor, or the like. There, image data 210 may be manipulated. Resulting compositing image data 208 is selectively combined with video image portion 214, to produce composite image data 216. Composite image data 216 is encoded using a discrete cosine transfer by DCT block 206. Resulting DCT coefficients are quantized using a quantization table. Quantized values are run-length encoded and provided to memory 128. In one embodiment, quantization parameters may be adjusted to ensure resulting encoded data fits within a certain size within memory 128. In the depicted embodiment, discrete cosine transformation, quantization and run-length encoding are all performed in accordance with the JPEG standard.

The depicted functional block elements are exemplary only, and may organized in many ways. They may be implemented in hardware, software or combination thereof. In one embodiment, the blocks are represented by a processor executing executable instructions for performing the specific operations associated therewith.

Notably, encoding is performed one image portion (or composite image portion) at a time. As such, memory 128 need only have sufficient capacity to store at least one encoded image portion (corresponding to an image portion or composite image portion in memory 122) at a time.

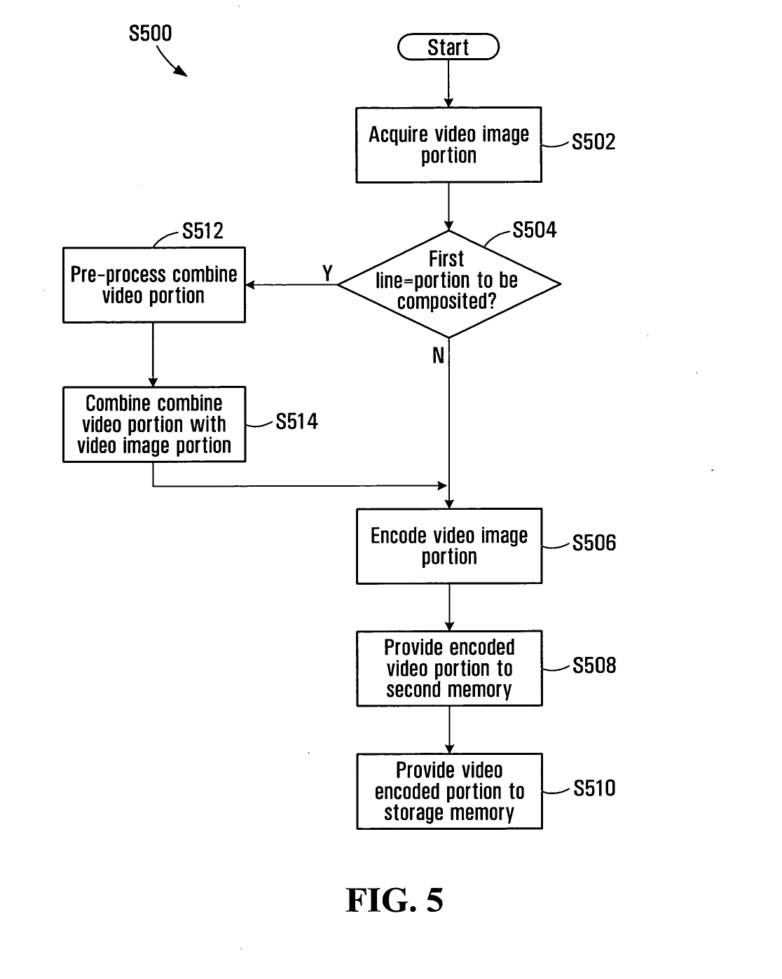

FIG. 5 illustrates a method S500 for image processing in device 100, exemplary of an embodiment of the present invention. The method begins, in block S502, by receiving a portion of a video image captured by camera 104 in memory 122. This may happen in response to an operator pressing a suitable control on device 102. As noted, first memory 122 has a storage capacity less than all image portions representing image 120. In the depicted embodiment, first memory 122 may be sufficient in size to store exactly 16 adjacent lines of image 120.

In block S504 processor 124 determines if the video image portion in memory 122 should be combined with image data in second memory 126. Processor 124 may, for example, keep a counter representing the current contents of memory 122. The counter may sequentially count the video image portions in memory 124, or track the starting line number of each video image portion with reference to image 120 for the video image portion currently stored in memory 122. The value of this counter may be compared to stored values representing the video image portions that are to be combined with image data in memory 126. The counter may also be used to decide how, or which image data within memory 126 is to be combined with video image portion within memory 122. The line numbers of the image to be modified may form part of the code used by processor 124, or be stored elsewhere, for example in memory 126. If the video image portion within memory 122 is to be modified (as determined with reference counter of image portions in memory 122 in block S504), graphics processor 124 may combine or replace all of, or a portion of the data in memory 122 with image data stored in second memory 126.

Prior to combining, the image data in second memory 126 may be optionally be pre-processed by being decompressed, coloured, filtered or otherwise modified in block S512.

In block S514 stored image data may be combined with video image portions. For example, image data representative of small image portion(s) may be stored in memory 126 and may be overlaid around the periphery of an image to form a border. Depending on the overlay image portions, the border may occupy an entire video image portion (e.g. for the top and bottom of the image), or only the edges of video images portions.

Next, after block S504 or S514, as the case may be, the video image portion (as optionally modified) is read from first memory 122, and encoded by encoding block of graphics processor 124 in block S506 to generate an encoded video image portion. As noted, the encoded video image portion may be a DCT encoded, quantized and run-length encoded version of the video portion within memory 122. Thereafter, the first encoded image portion is provided to third memory 128 in block S508. The encoded image portion may optionally be written to storage memory 130 after being modified and/or graphically processed by the processor 124 in step S510.

Method S500 may be repeated for each video image portion until the entire video image 120 is processed. Thereupon, the method is complete.

Display processor 140 may optionally read data from memory 128, as it arrives in memory 128 and decode it and display it on display 102.

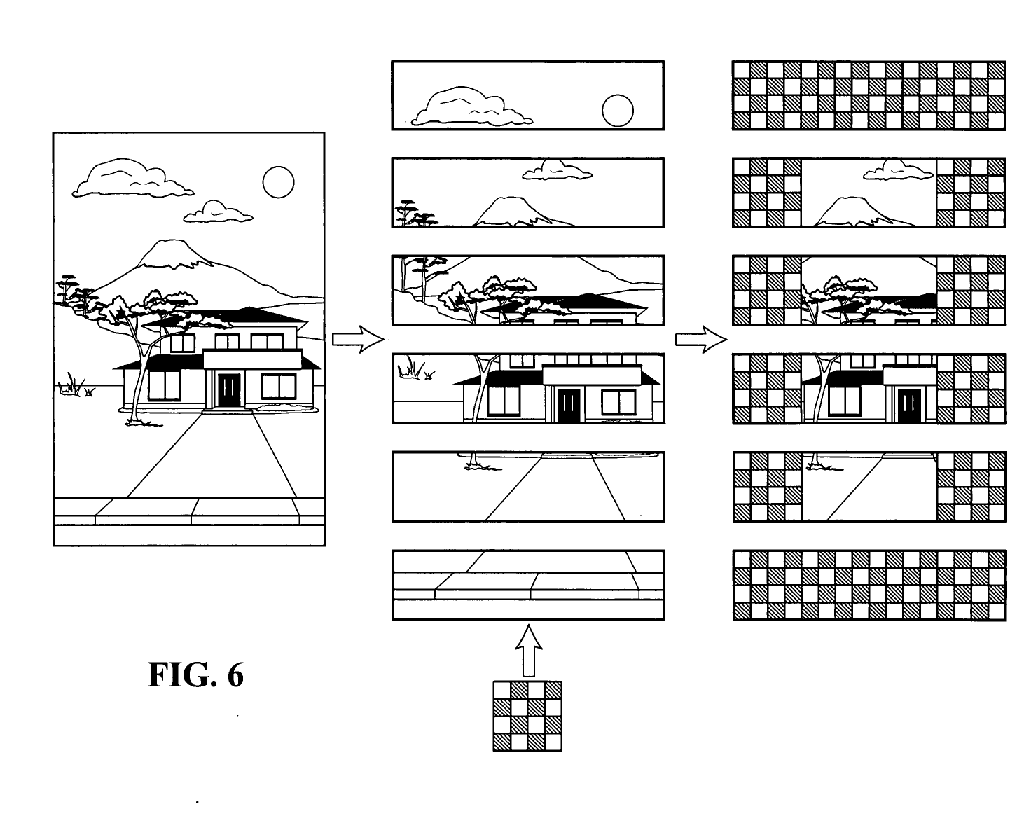

Example image compositing is depicted in FIGS. 6-8. In FIG. 6, for an example video image 120, the contents of memory 122 is depicted for each of a plurality of video image portions. In the depicted embodiment, each video image portion is formed of sixteen (16) lines of video image 120. Each image portion may, for example, be formed of 16 contiguous lines, or 16 alternate (e.g. odd or even) lines of video image 120. As illustrated, image 120 is passed to memory 122, in six (30) portions of sixteen (16) lines. The portions of video image 120 are passed to memory 122 and processed, sequentially.

In the depicted example, image data stored within memory 126 takes the form of a 16×16 pixel checker-pattern. Each square of the checker pattern is formed as a 4×4 block of pixels.

Now, in the example of FIG. 6, the first and last image portions of image 120 are replaced entirely with data from memory 126. That is, the checker-board pattern is repeatedly block transferred to memory 122, in place of the first and last portions of image 120. Image data from memory 126 may be transferred 16×16 blocks at a time, or line by line to fill lines within memory 122. Video image portions 2-5 of image 120 are modified by replacing the first and last 16×16 pixel blocks within memory 122 with the 16×16 block in memory 126. The resulting image portions/composite image portions are of course encoded.

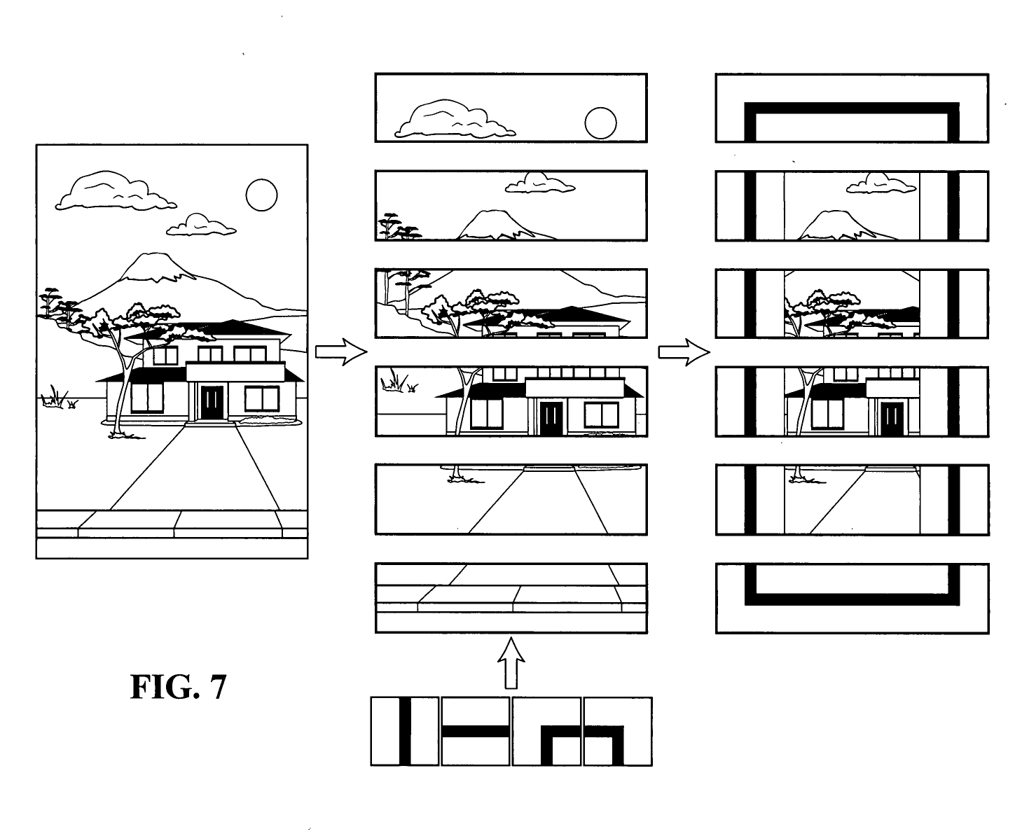

In a further alternate example depicted in FIG. 7, image data in memory 126 includes six different 16×16 blocks that are combined and placed on a captured image 120, to form a border. Four of the six blocks are used for each of the corners of the frame of image 120, while the remaining two blocks are used for horizontal and vertical portions of the frame around a captured image. Block S514 (FIG. 5) may be takes into account which image data within memory 126 is combined with each video image portion within memory 122.

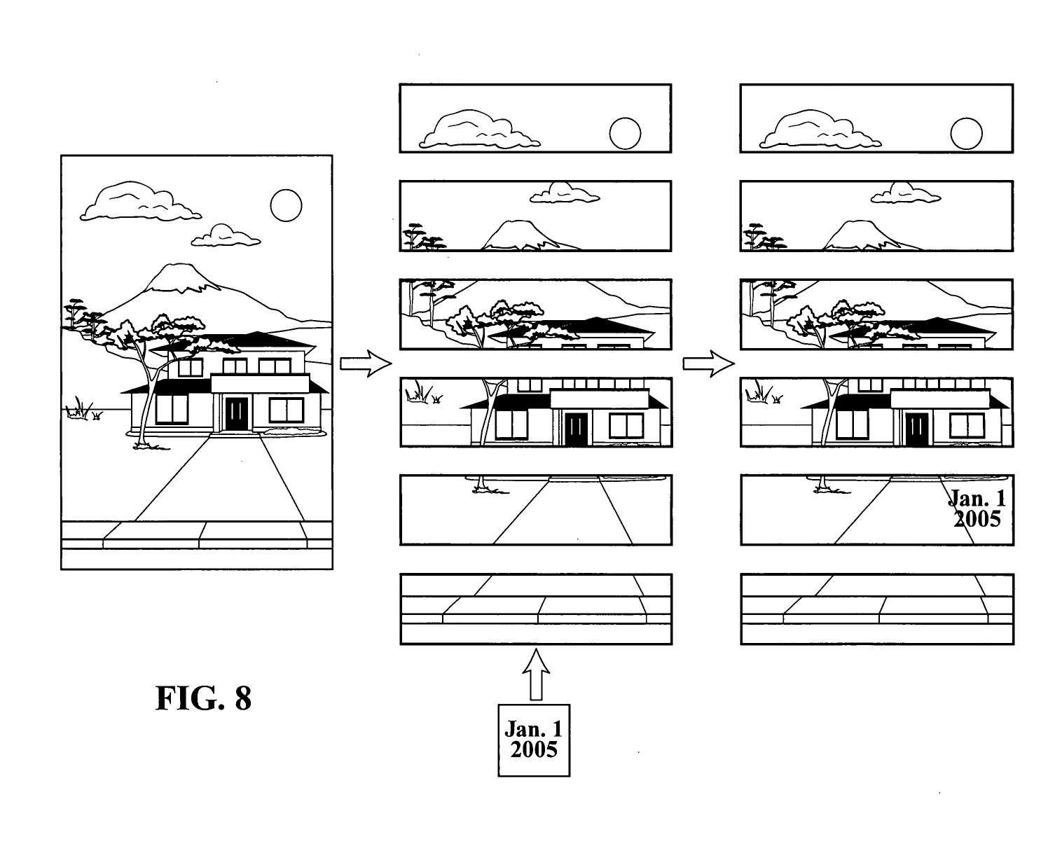

In yet a further embodiment, memory 126 may store an image representative of the current time or date, as depicted in FIG. 8. The time or date may be added to a captured image at an appropriate location (line and/or horizontal offset). As depicted in FIG. 8, image data within memory 126 need not be used to replace data in memory 122, but may instead be ORed or otherwise combined with video image data in memory 122. For example, the overlay image may be modified to provide a translucent overlay on image 120.

As will now be appreciated, device 10 and the disclosed methods provide great flexibility in compositing images. Image data representative of multiple alternative compositing options may be stored in memory 122. For example, data for multiple borders, icons or the like may be stored in memory 122. An end-user of device 100 may select which of the multiple alternatives is used. As well, the relationship of the size of image portions stored in memory 122 to image 120 is flexible. The image portions may be smaller or of equal size to image 120.

Conveniently, memory 122,128 need not be sufficiently large to store an entire image 120, or an encoded version thereof. Similarly, the size of memory 122 is not related to the size of image 120 and may thus be arbitrarily large or small.

As will be further appreciated, methods exemplary of the present invention may similarly be used to perform video compositing on moving video, in much the same way as still images. Instead of encoding a still image in portions in memory 122, images within memory 122 are encoded using a motion picture encoding method such as MPEG 1, 2 or 4 or any other present or future encoding technique. Again, video image portions may be modified with data in memory 126, prior to encoding in much the same way as described above.

The present invention thus provides for improved graphic processing within the image processing pipeline by providing for the efficient utilization and processing of video data portion by portion. Through the use of limited sized memories and processing video images on a portion-by-portion basis, a reduction in memory-size requirements can be achieved resulting in valuable real-estate savings within a portable device.

The exemplified embodiment of the invention is embodied in a portable (cellular) telephone including a camera. As will now however be appreciated, the invention could be embodied in a large assortment of devices, such as a still camera, video camera, printer, portable digital assistant, laptop (or other) computer, or the like. The processed video frame need not originate with a camera at the device, but could instead be received over a network wirelessly from memory, from an external interconnected camera, or the like.

It should be understood that the implementation of other variations and modifications of the invention in its various aspects would be apparent to those of ordinary skill in the art, and that the invention is not limited by the specific embodiments described herein. For example, the image processing may be performed using any encoding technique, above and beyond the disclosed MPEG and JPEG encoding technique for video data.

The above described embodiments are intended to be illustrative only and in no way limiting. The described embodiments of carrying out the invention, are susceptible to many modifications of form, arrangement of parts, details and order of operation. The invention, rather, is intended to encompass all such modification within its scope, as defined by the claims.

What is claimed is:

1. An apparatus for processing a video frame in a device, the video frame divisible into a plurality of video image portions, the apparatus comprising:
a first memory that receives said video image portions, said first memory having a storage capacity less than all of said plurality of video image portions of said video frame,
a second memory storing image data to be combined with said video frame;
a graphics processor coupled to said first memory and said second memory to selectively combine data within said first memory and image data within said second memory to produce at least one composite video image portion, and to encode at least some of said video image portions and said composite image portion video image portion to form an encoded video image; and
a third memory receiving said encoded video image.

2. The apparatus of claim 1, wherein said second memory stores data representative of one of a watermark or border to be combined with said video frame.

3. The apparatus of claim 1, wherein said image portion in said second memory is smaller than said video frame.

4. The apparatus of claim 1, further comprising a filter in communication with said second memory to filter said image portion prior to said combining.

5. The apparatus of claim 1, further comprising an image decompressor in communication with said second memory to decompress said image portion prior to said selectively combining.

6. The apparatus of claim 1, wherein said selectively combining comprises replacing portions of said first image portion in said first memory with data from said second memory.

7. The apparatus of claim 1, further comprising a storage memory for storing said encoded video image in communication with said third memory.

8. The apparatus of claim 1, wherein said first memory sequentially receives all video image portions of the video frame.

9. The apparatus of claim 1, wherein said graphics processor generates a plurality of encoded video portions and provides said plurality of encoded video image portions to said third memory on a portion-by-portion basis.

10. The apparatus of claim 1, wherein said third memory provides said plurality of video image portions to said external memory on a portion-by-portion basis.

11. The apparatus of claim 1, wherein said graphics processor applies a discrete cosine transform to said video image portions to form the encoded video image portions.

12. The apparatus of claim 11, wherein said graphics processor JPEG encodes the image portions to form said encoded video image.

13. The apparatus of claim 1, further comprising: at least one display controller operably coupled to said third memory to provide an output display therefrom.

14. The apparatus of claim 1, wherein said graphics processor uses a quantization table for generating said encoded video portions.

15. The apparatus of claim 1, wherein said first memory is a first portion of an embedded memory device and said second memory is a second portion of said embedded memory device.

16. The apparatus of claim 1, wherein each of said image portions comprises a plurality of sequential lines in said video image.

17. The apparatus of claim 1, further comprising a camera in communication with said first memory

18. The apparatus of claim 17, wherein said camera comprises a charge-coupled-device.

19. A method of compositing a first image with a second image comprising:
receiving said first image as a plurality of image portions of video data;
writing each portion of video data to a first memory having a storage capacity insufficient to store all of said plurality of image portions of video data;
storing data representing said second image;
selectively combining at least one of said portions of video data in said first memory with data within said data representing said second image to form at least one composite video image portion;
graphically processing portions of video data from said first memory, and said at least one composite video image portion to generate encoded video portions; and
writing said encoded video portions to a storage memory.

20. The method of claim 19, wherein said graphically processing said plurality of video portions comprises discrete cosine transforming each one of said plurality of video image portions.

21. The method of claim 20, wherein said graphically processing the plurality of video portions comprises JPEG encoding each one of said plurality of video image portions.

22. The method claim 21, wherein said first memory and said storage memory are disposed within an embedded memory.

23. The method of claim 22, further comprising receiving said video image from a camera disposed within said device.

24. The method of claim 22, wherein said second image comprises a border to be placed about said first image.

25. The method of claim 19, further comprising selecting said second image from a plurality of available images stored in a second memory.

26. The method of claim 19, wherein each of said video image portions comprises a plurality of sequential lines of said image.

27. The method of claim 27, wherein each of said video image portions comprises sixteen sequential lines of said image.

28. An apparatus for processing a video frame in a device, the video frame divisible into a plurality of video image portions, the apparatus comprising:
a first memory for receiving and storing individual ones of said video image portions, without concurrently storing of all of said plurality of video image portions of said video frame,
a second memory storing image data to be combined with said video frame;
a graphics processor coupled to said first memory and said second memory to selectively combine data within said first memory and data within said second memory to produce at least one composite video image portion, and to encode at least some of said video image portions and said composite image portion video image portion to form an encoded video image; and
a third memory receiving said encoded video image.
